(19) United States
(12) Patent Application Publication
(10) Pub. No.: US 2024/0270362 A1
(43) Pub. Date: Aug. 15, 2024

(54) SAIL PROPULSION ELEMENT, SAIL-PROPELLED VEHICLE

(71) Applicant: COMPAGNIE GENERALE DES ETABLISSEMENTS MICHELIN, Clermont-Ferrand (FR)

(72) Inventors: OLIVIER ESSINGER, Clermont-Ferrand (FR); BRUNO FRAGNIERE, Clermont-Ferrand (FR); EDOUARD KESSI, ST-PREST (CH); LAURENT DE KALBERMATTEN, Riaz (CH)

(21) Appl. No.: 18/564,781

(22) PCT Filed: May 30, 2022
(86) PCT No.: PCT/FR2022/051018

§ 371 Date: Nov. 28, 2023

(30) Foreign Application Priority Data
May 28, 2021 (FR) FR2105608

(51) Int. Cl. B63H 9/061

(52) U.S. Cl. CPC B63H 9/0615

(57) ABSTRACT

A sail-propulsion element comprises a mast (3), an inflatable sail (1) consisting essentially of two substantially fluidtight adjacent surfaces (4a, 4b) joined together along their periphery, thus forming between them at least one cavity closed around the mast (3), at least one air conduit positioned between the inside and the outside of the cavity, at least one means for injecting air into said cavity, the sail once inflated having a profile that remains permanently symmetrical, irrespective of the movement of said propulsion element, or of the direction or strength of the wind, a headboard, and a sail. The sail comprises a plurality of cells (5) in the direction of the span of the sail, each cell (5) extending from the leading edge (6) to the trailing edge (7), said cells (5) being spaced apart by ribs made of a first soft material.

The invention relates to an inflatable sail, and falls within the field of sail propulsion or that of hybrid sail propulsion.

A reminder of some definitions used hereinafter is given below:
Reefing: consists in reducing the surface area of a sail by partly furling it from the bottom so as to adapt the surface area of the sail to suit the strength of the wind. The reefing may be done manually or automatically.
Reefing bands: partially reinforced horizontal zones to which reefing turning blocks can be attached, with, for example, grommets or pulleys. These reefing bands are positioned on the sail at the rib at each height at which the sail has a reefing point. There are as many reefing bands as there are possibilities to reef the sail.
Lazy jacks: devices for guiding the sail during the operations of reefing and of dropping the sail.
Boom: horizontal spar articulated to the base of the mast and which holds and permits orientation of certain sails. The boom may also receive the sail when the sail has been dropped. Certain sailboats have a mast roller; the sail is then stored in the mast.
Luffing: a sail which is luffing is insufficiently hauled in and has therefore partially deflated. A well trimmed sail needs to be on the limit of luffing. With a properly filled sail there is no luffing so it is possible to sail close to the wind.
Leading edge: the front part of an aerodynamic profile (wing, propeller, etc.) at which a fluid will divide into two streams.
Trailing edge: a characteristic part of any profile (wing, keel, rudder blade, etc.) subjected to a flow of a fluid (air, water, etc.) on each side of it. It designates the part opposite to the sense of direction or, in other words, the rear part when considered in the direction of the flow.
Headboard: the upper end of the sail which conforms to the upper contour of the sail.
Dropping: consists in lowering the sail.
Hoisting: consists in raising the sail.
Rigging: collection of fixed and moving parts of a boat of the sailboat type that allows the boat to be propelled and maneuvered.
Sail receptacle: in addition to receiving the dropped sail, it may incorporate other functions, such as reacting the tension supplied by the sail or else housing other actuators, energy storage sensors and control module which are used for operating the sail.
Hydrodynamic drag: the force of friction between the boat and the water. The higher the drag, the more the boat slows.
Aerodynamic drag: a component of the force experienced by a body moving through a fluid and that is exerted in the opposite direction to the direction of the movement. According to the invention, the sail generates aerodynamic drag.
Aerodynamic lift: a component of the force experienced by a body moving through a fluid and that is exerted perpendicular to the direction of the movement. According to the invention, the sail generates aerodynamic lift.
Relative wind or apparent wind: the vector sum of the wind created by the boat's own speed and the actual windspeed.
Aerodynamic resultant: the vector sum of the aerodynamic lift and of the aerodynamic drag.

### PRIOR ART

A sail-propulsion element comprising an inflatable sail with a symmetrical profile is already known from document WO 2017/221117A1. This propulsion element comprises an inflatable sail consisting essentially of two substantially fluidtight adjacent surfaces joined together along their periphery, thus forming at least one closed cavity. The element further comprises a conduit positioned between the inside and the outside of the cavity and means for injecting air into the cavity. Once inflated, this sail has a profile that remains permanently symmetrical, irrespective of the movement of the element, or of the direction or strength of the wind. The sail in that document is constantly being inflated while it is being used for sailing.

Unfortunately, a soft sail such as this has the disadvantage of not offering a level of inflation that is suited to the various stages of its use, notably during the hoisting and dropping phases. Specifically, unlike a hard sail, a soft sail has no clearly defined position for these stages of handling (hoisting and dropping). During these stages, it is important to keep the sail close to the axis of symmetry of the sail profile, so as to avoid the sail falling into the water or becoming caught on an element close by, or not collapsing in a heap suitable for being stowed compactly. Moreover, it is important to maintain a slight pressure in the sail during the dropping or reefing phase so as to prevent it from luffing, as this could reduce its life.

Finally, such a sail requires the presence of a number of air-injection points, so that it can be hoisted when furled, thus requiring adaptations to the structure of the fabric from which the sail is made, yet without enabling rapid and reliable deployment of the furled sail.

Again, document WO2009043823A1 discloses a paraglider of which the wing profile, which extends from the leading edge to the trailing edge, comprises a plurality of cells in the direction of the span of the sail, these being spaced apart from one another by ribs. Such a paraglider comprises various air inlet openings downstream which serve to fill the first storage space during flight.

Unfortunately, such a sail comprises different categories of cells, which do or do not have openings intended for the passage of air. These cells are provided not solely for the even and continuous transmission of air from one cell to another, until such point as the furled sail is fully deployed, but also for ejecting air during partial or total dropping of the sail, without the risk of the sail falling into the water. Finally, an irregular distribution of the openings over the volume of the sail tends to cause difficulties to be encountered in deploying the sail because of the significant probability of blockages at the orifices as a result of their not being properly aligned for allowing the air to pass.

### SUMMARY OF THE INVENTION

Thus there is still a need for an inflatable sail which, during dropping/inflating, transmits the air uniformly and evenly through the entire volume of the sail while remaining correctly on its axis of symmetry along the mast, without luffing, and without risk of becoming damaged, and which can be fully or partially deployed repeatedly, either manually or automatically. Furthermore, even in the deployed position, there is still a need to be able to minimize the consumption of the inflation devices and to be able to place them in the sail receptacle so as to simplify the supply of electrical power.

One subject matter of the invention is a sail-propulsion element, comprising a mast, an inflatable sail consisting essentially of two substantially fluidtight adjacent surfaces joined together along their periphery, thus forming between them at least one cavity closed around the mast, said sail comprising an upper part, a lower part, a leading edge and a trailing edge, at least one air conduit positioned between the inside and the outside of the cavity of the sail, at least one means for injecting air into said cavity, the sail once inflated having a profile that remains permanently symmetrical, irrespective of the movement of said propulsion element, or of the direction or strength of the wind, a headboard positioned on the upper part of the sail, and a sail receptacle positioned between the leading edge and the trailing edge on the lower part of the sail.

The propulsion element according to the invention is characterized in that the sail comprises a plurality of cells in the direction of the span of the sail, each cell extending from the leading edge to the trailing edge, said cells being spaced apart by ribs made of a first soft material that allows air to pass, for example a structure of 3-D type.

A rib thus delineates two adjacent cells, several ribs being provided to delineate the various cells of the sail. It is advantageous for the rib to allow the air to pass, to minimize the pressure drop but also to be able to transmit load. The importance of being able to minimize the pressure drop experienced by the air during inflation, which is to say the level of pressure that the air needs to overcome in order to travel its full path, should be emphasised here. Specifically, when the sail is dropped and the operator wishes to inflate the sail with air, it is of key importance that the blown air which, in the solution of the invention, arrives from the bottom of the sail, should not remain trapped in the lowermost box section (or bottom cell) but should, during inflation, be able to access the top part of the sail (the top cells of the sail) as easily as possible. Positioning between the cells, as the invention proposes, ribs that are able to allow the air to pass provides a solution to this problem because it is now the entire surface area of the rib that can be used for allowing the air to pass. Thus, in contrast to configurations of the prior art in which the air has to pass through a few holes formed in the rib and in which the pressure drops may be greater depending on the way in which these ribs are stacked when the sail is dropped, the air here always manages to find an easy path for supplying all the cells, particularly those in the upper part of the sail.

The propulsion element according to the invention offers the following various advantages.

Thanks to a continuous passage of air through each rib, the air circulates evenly and uniformly from one cell to another. Specifically, even though only one single air injection point is present, the fact that the ribs allow the air to pass through them over substantially their entire surface area makes it possible to obtain an internal pressure that is practically uniform throughout the entire volume, thereby ensuring the precision of the profile of the sail. The presence of such ribs makes automatic inflation and furling, following the deflation of the sail, easier, notably using solely the fans present in the sail receptacle, which are therefore situated in the lower part of the sail, and without any external intervention whatsoever. The air-permeable ribs improve the transmission of the air in comparison with the existing solutions, while situating the fans at the lower part of the sail. Thus, in inflatable sails of the prior art, the air arrives via multiple orifices and fans positioned on the leading edge of the sail, so that the electric power supply cables need to pass through the various cells in order to connect the fans. Using ribs which are air-permeable over substantially their entire surface area, the supply of electrical power to the actuators (fans) is simplified and these can thus be situated in the sail-receiving receptacle, and therefore in the lower part of the sail, while at the same time offering uniform inflation throughout the entire volume of the sail. The fans may be replaced by other means of injecting air, such as, for example, blowers, or a pressurized air feed.

What is meant by a symmetrical profile is a profile which is perfectly symmetrical when the pressures on the intrados and extrados sides of the wing are equal, but which can vary slightly, given the softness of the sail (which is incidentally referred to as a wing when speaking of an inflated sail) when the difference in pressure between the intrados and extrados sides of the sail causes a slight deformation of the profile.

As a preference, each rib comprises a reinforced zone delimited around the mast and made from a soft composite material that is reinforced so as to be able to transmit load.

As a preference, the first and the second soft materials are woven materials having different weaves.

As a preference, the first soft material has a mesh size of around 2 to 4 mm.

As a preference, the second soft material has a mesh size of around 2 to 4 mm.

As a preference, the rib comprises a central band which extends from the leading edge to the trailing edge.

As a preference, the central band is made from the second soft material. In an alternative form of the invention, the central band is solid.

As a preference, the central band has a width ranging from 1 to 10 cm.

As a preference, the cells are spaced apart by a distance of between 0.8 and 2 m.

As a preference, discrete reinforcers are positioned evenly along the leading edge.

As a preference, a guide line is positioned in the closed cavity of said sail, for the manoeuvres of hoisting and dropping the sail, said guide line extending from the leading edge to the trailing edge of said sail, passing through the headboard and the sail receptacle, said guide line passing through the discrete reinforcers. It is recalled that the guide line is a device produced through line rope cordage to allow the sail to be correctly geometrically positioned during operation and during the phases of hoisting or dropping. Specifically, a rib of the sail, for example considered midway up the height of this sail, is positionally constrained by the fact that it allows the mast to pass through a hole formed for that purpose, but apart from the rigidity of the sail (which is low) there is nothing to prevent it from rotating about the mast under the effect of the pressures applied to the sail. Such rotation would have the effect of causing the sail to twist, therefore modifying its profile in a way detrimental to its performance. To avoid this twisting, each rib has the guide line passing through it at a point sufficiently distant from the mast. During hoisting or dropping, the rib slides along the mast and along this guide line.

As a preference, when a guide line is present, it is formed as one part and is attached fixedly to the sail receptacle on the trailing edge and able to be moved by a roller on the leading edge, or else is able to be moved by a roller in the sail receptacle on the trailing edge and fixedly attached to the leading edge, and in that the guide line is positioned along the headboard such as to be able to move over at least one pulley between the trailing edge and the leading edge.

As a preference, when a guide line is present, it is formed as two parts, the first part on the side of the trailing edge is fixed or else able to be moved with a pulley on the headboard and able to be moved by a roller on the sail receptacle; the second part on the side of the leading edge is fixed or else able to be moved with a pulley on the headboard and able to be moved by a roller on the sail receptacle.

Another subject matter of the present invention is a vehicle with sail propulsion or hybrid propulsion comprising at least one sail-propulsion element as mentioned hereinabove, a hull and a mast secured to said hull while still maintaining a degree of freedom to rotate. This vehicle is characterized in that most of the mast is positioned inside the cavity of the above-mentioned inflatable sail.

As a preference, the mast is positioned inside the cavity of said inflatable sail.

As a preference, the sail is oriented according to the wind direction and according to the direction of travel of the vehicle either manually or automatically.

What is meant by a hybrid-propulsion vehicle according to the invention is sail propulsion coupled with another source of propulsion such as, for example, propulsion by means of a propeller driven by an electric motor or a combustion engine, having, as energy store, batteries, hydrogen (with fuel cell), natural gas or fuel oil.

What is meant by a vehicle is any craft which may or may not have wheels, moving on land or on water.

### DESCRIPTION OF THE DRAWINGS

The invention will be described with the aid of the following figures, which are schematic and not necessarily drawn to scale, and in which:

FIG. 1 provides a reminder of the various physical forces that are applied to a ship, for example of the motor sailboat type, and notably the projection of the resultant aerodynamic force;

FIG. 2 is a schematic front view of the sail-propulsion element according to the invention, fully hoisted;

FIG. 3 is a schematic front view of the sail-propulsion element partially comprising ribs;

FIG. 4 is an enlarged schematic view of the rib-comprising portion of the sail-propulsion element according to the invention;

FIG. 5 is rib a schematic front view of the sail-propulsion element according to the invention, fully furled;

FIG. 6 is a schematic perspective view of a rib.

Before the sail-propulsion element that forms the subject matter of the present invention is explained in greater detail, with the aid of the above-mentioned figures, a reminder of a few hydrodynamic and aerodynamic definitions is given below.

A sail-propulsion vehicle, hereinafter referred to as sailboat or ship, is in contact with the air and with the water. From a physical standpoint, the predominant factors are the hydrodynamic and aerodynamic forces that are applied to the hull, the sails and the appendages (centreboards, keel, rudder, propeller).

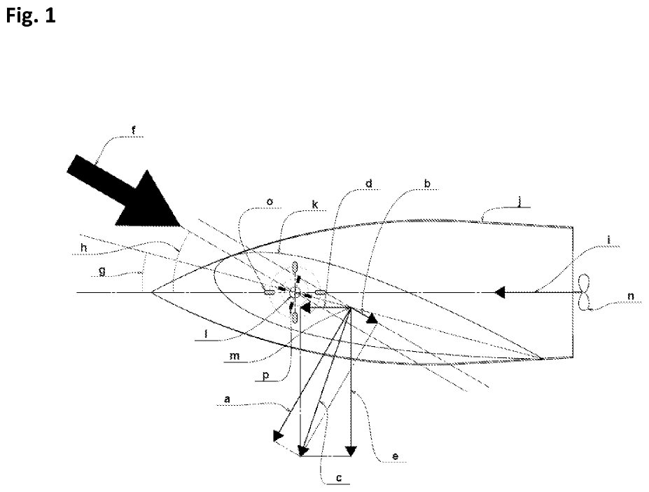

As shown in FIG. 1, the aerodynamic force (or sail thrust) is the result of the air being deflected by at least one sail. The aerodynamic force is relative to the position and surface area of the sail and to the position and strength of the relative wind. The drag force is in the direction of the relative wind, the lift force is in the direction perpendicular to the relative wind, and is not always perpendicular to the sail. For example, at 0°, a symmetrical profile creates no lift because the air covers strictly the same distance over the extrados surface and the intrados surface. At that point, it generates only drag.

The aerodynamic force generated by the sail may also be broken down in the frame of reference of the boat, rather than that of the sail, into a sail-propulsion force (along the axis of travel of the boat) and a drift force (perpendicular to the axis of the boat) which may cause a boat to heel (heeling being the transverse inclination of a boat as caused by an external phenomenon such as the wind).

The hydrodynamic force is the result of the friction of the water against the hull and the centreboard or keel and the various underwater appendages. Its direction is dependent on the aerodynamic force that it opposes, on the propulsion force in hybrid mode, on the sea state and on the marine currents. The longitudinal component is referred to as hydrodynamic drag and the transverse component is referred to as side force, anti-heeling force or hydrodynamic lift. The direction and the intensity of the hydrodynamic force are not dependent solely on the aerodynamic force. For a surface vessel (boat) operating in hybrid mode (wind and another energy source), the hydrodynamic force will be greatly dependent on the vessel speed generated by the engine or motor propulsion, for example, on the sea state and on the marine currents.

When the sail force is greater than the hydrodynamic force, the boat accelerates. When the sail force is lower than the hydrodynamic force, the boat slows down. Further, if the aerodynamic force is greater, but directed toward the rear of the boat, the boat will slow down. If the hydrodynamic force is in the direction of travel of the boat (because the current is strong), the boat will accelerate.

It is by optimizing the trim of the sail that the sailboat will achieve its maximum performance in terms of sail thrust in the direction of travel. Specifically, it is by optimizing the angle of the sail relative to the relative wind and to the direction of the boat, and by trimming the surface area of the sail that the boat can be made to achieve the maximum level of sail propulsion along the axis of the boat. An additional trimming operation may be needed, depending on the wind conditions, in order to vary the internal pressure in the sail. This then makes it possible to increase the speed of the boat or, on the other hand, to maintain the same speed while at the same time reducing the consumption of other energy sources, by virtue of sail propulsion.

FIG. 1 repeats each of the foregoing defined parameters with its own specific reference, all as listed hereinbelow:
a: Lift force
b: Drag force
c: Aerodynamic resultant force
d: Aerodynamic thrust force (along the axis of the ship)
e: Aerodynamic drift force
f: Relative wind
g: Relative angle between wing and boat axis (e.g. 15°)
h: Angle between relative wind and boat axis (e.g. 30°)
i: Propeller propulsion force
j: Hull
k: Sail
l: Mast
m: Centre of aerodynamic thrust
n: Propeller
o: Sensor on fixed part (hull frame of reference)
p: Sensor on moving part (sail frame of reference)
   The information given in FIG. 1 allows transition from sensors of data in the frame of reference of the hull to the sensors of data in the frame of reference of the sail, and vice versa.

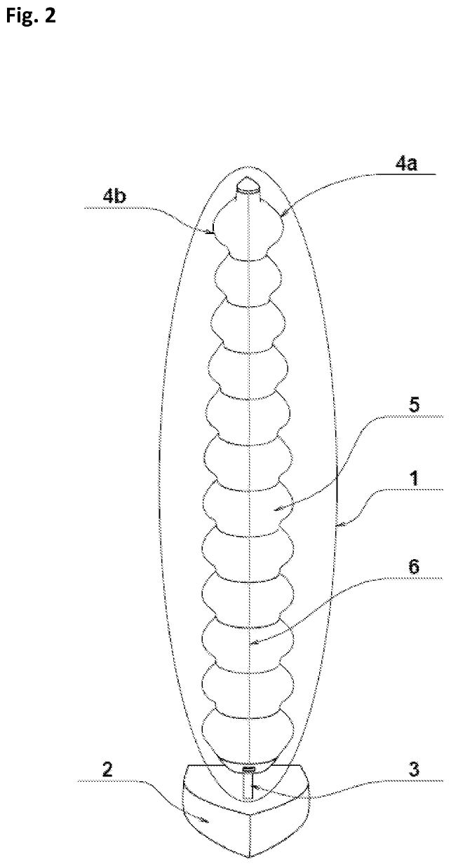

FIG. 2 depicts the propulsion element with general reference 1 according to the invention, mounted on a hull 2 of a boat, of the sailboat type, using a self-supporting mast 3. The mast 3 is connected to the hull using a support (not depicted) intended to absorb the load of the physical forces. Loads are measured at the support or at the mast itself. The sail comprises two adjacent surfaces 4a and 4b which are connected to one another in such a way as to form a closed cavity. Each surface 4a, 4b may be made of a material having several layers, so as to achieve the various characteristics such as mechanical strength, airtightness, resistance to fire, and UV resistance.

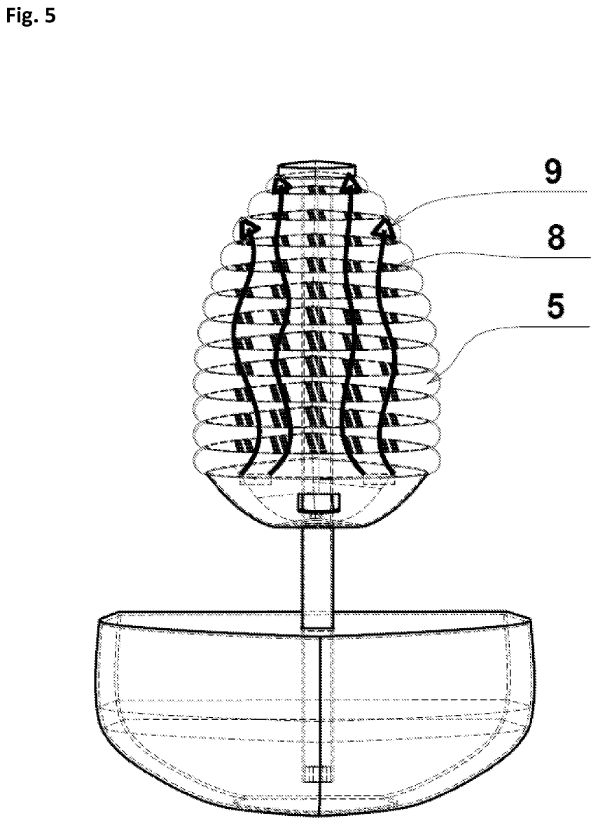

The sail 1 comprises several cells 5 distributed over the entire height of the sail 1 in the direction of the span. Each cell 5 extends from the leading edge 6 to the trailing edge 7 (as indicated in FIG. 5). The cells 5 are spaced around 1 m apart.

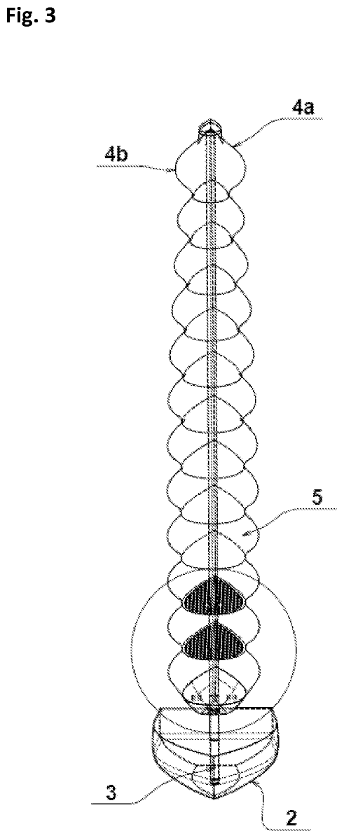

As shown in FIG. 3, the cells 5 are separated from one another by a rib 8. Each rib 8 is made of a first material, for example a woven material consisting of warp yarns with a weft fill of around 3 mm, with the yarns potentially coated with a compound such as PVC. This type of 3-D weaving ensures correct passage of air even when the sail is furled, in the dropped mode.

This first material which may be a woven material is attached to the sail by an adhesive means, by stitching or by fusion bonding or by any other means that allows secure attachment. No subsequent coating is performed because this would block the pores of the material and prevent the air from circulating correctly.

It is even possible to use by way of first woven material a fabric that effects a progressive transition between the material constituting the external layer of the sail 1 and the first woven material of the rib 8. It is also possible to use filament membrane.

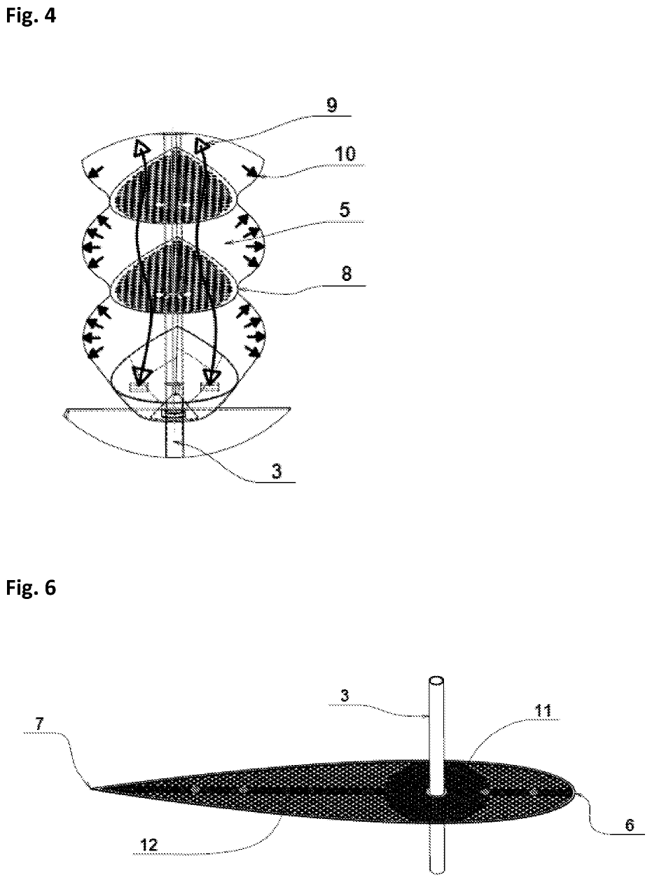

As shown in FIG. 4, each of the cells 5 are separated by a rib 8. During hoisting/dropping, the air, handled by the fans, or any other means of inflation, and located for example in the sail receptacle, is blown or sucked into the cavity of the sail. The air passes through the ribs 8 (arrows 9) from the top down or from the bottom up (depending on whether the sail is being inflated or deflated), thus allowing a substantially uniform distribution of the internal pressure in the sail 1, whether the case is that of a sail that is fully deployed, that of a sail that has had the sail area reduced by reefing, or that at the start of inflation while the ribs are stacked.

The make-up of the ribs 6 also makes it possible to react load associated with the internal pressure of the sail 1 as well as making it possible to transmit to the mast 3 the aerodynamic pressure applied to the profile of the sail 1. Indeed the ribs react the internal pressure of the sail, and are also able to transmit aerodynamic forces.

As symbolized (arrow 10), the internal pressure of the sail is exerted against the wall of the sail.

The particular choice of the first woven material according to the invention for the ribs 8, and notably the orientation of the yarns of which this material is made, allows the aerodynamic forces to be transmitted correctly from the sail to the mast 3. A limited passage of air around the mast 3 is not disadvantageous. What is of greatest importance is for the air to be allowed to pass over the front part of the rib (towards the leading edge) and over the rear part of the rib (towards the trailing edge). In other words, the rib is not fixed to the mast but “floating”. This nevertheless allows aerodynamic forces to be transmitted while at the same time making it possible to distribute the air uniformly throughout the entire volume of the sail.

The first benefit of using the first material that allows the air to pass and that reacts load according to the invention, unlike discrete orifices distributed over the surface of the sail, is that it avoids partial or complete obstruction of one or more orifices, which would have a far greater detrimental effect on the correct circulation of the air in the cavity of the sail 1.

The second benefit is that it makes it possible to appreciably reduce the pressure drops while at the same time maintaining sufficient strength for transmitting load, thus reducing the power and, therefore, energy consumption of the inflation devices.

A final benefit of this first material is the possibility to dispense with fans in the leading edge. With the solution of the invention, the fans positioned in the sail receptacle will suffice for most manoeuvres entailing blowing air in or withdrawing air.

As shown by FIG. 5, the cells 5 allow the air (arrow 9) to pass upwards over the completely furled element according to the invention, so as to hoist the sail 1.

The schematic depiction in FIG. 6 shows a reinforced zone 11, delimited around the mast 3, in the lower part of the sail. This zone has a surface area of around 7.5 m². It is made from a second material different from the first material, which may for example be produced using the same material but with a different angle, for example the first material having a weave angle of 0 and 90° and the second material having an angle of +/−45° with respect to the first material. In an alternative form, this reinforcement may be achieved by using the same woven fabric as that of the rib and by superposing two layers of fabric at 45° relative to one another.

This second material is defined by a mesh opening of around 3 mm in size.

FIG. 5 further shows the presence of a band 12 made of a reinforcing material. This band 12 has a width around 80 mm.

Its function is to distribute force and limit abrasive wearing at the points through which the various line cordage, such as the reefing lines or the guide line, pass.

Discrete reinforcers (not depicted) may be positioned evenly along the leading edge and/or the trailing edge at the ribs 6.

### Example

The example which follows is given solely by way of example and is entirely non-limiting. The table below collates various possible situations

| | Sailboat | Cargo vessel |
|---|---|---|
| Length of boat (in metres) | 13 | 140 |
| Number of sails | 1 | 8 |
| Sail rib - polyester (g/m²) | 220 | 240 |
| Sail external layer in coated | 110 | 160 |
| polyester (g/m²) | | |
| Height of sail (in metres) | 17 | 40 |
| Longest length of sail (in metres) | 8 | 17 |
| Greatest width of sail (in metres) | 1.8 | 3.5 |
| Surface area of sail (m²) | 100 | 500 |
| Number of cells | 30 | 35 |

The external layer of the sail, also referred to as the body, is made from a woven fabric comprising an external part in contact with the exterior air, and an internal part. This fabric may be a woven polyester coated with polyurethane. The grammage of this fabric may be 180 g/m² for approximately 100 m² sail area.

The upper part of the sail may be secured using hook and loop strips of the Velcro type. The connections between the outer parts of the sail and the ribs (internal connections) and the connections between the constituent elements of the outer part may be achieved by fusion bonding or adhesive bonding or any other means of connection (zip-fasteners for example) which are able to ensure both a sufficiently low level of permeation compatible with the existing inflation system while also ensuring that load is transmitted.

1.-13. (canceled)

14. A sail propulsion element comprising:
a mast (3);
an inflatable sail (1) consisting essentially of two substantially fluidtight adjacent surfaces (4a, 4b) joined together along a periphery of the surfaces, forming between them at least one cavity closed around the mast (3), the inflatable sail comprising an upper part, a lower part, a leading edge (6) and a trailing edge (7);
at least one air conduit positioned between an inside and an outside of the at least one cavity of the inflatable sail;
at least one means for injecting air into the at least one cavity, the inflatable sail once inflated having a profile that remains permanently symmetrical, irrespective of movement of the sail propulsion element, or of a direction or strength of wind;
a headboard positioned on the upper part of the inflatable sail; and
a sail receptacle positioned between the leading edge (6) and the trailing edge (7) on the lower part of the inflatable sail,
wherein the inflatable sail comprises a plurality of cells (5) in a direction of a span of the inflatable sail, each cell (5) extending from the leading edge (6) to the trailing edge (7), the plurality of cells (5) being spaced apart by ribs (8) made of a first soft material that allows air to pass.

15. The sail propulsion element according to claim 14, wherein each rib (8) comprises a reinforced zone (11) delimited around the mast (3) and made from a composite second soft material.

16. The sail propulsion element according to claim 15, wherein the first soft material and the composite second soft material are woven materials having different weaves.

17. The sail propulsion element according to claim 14, wherein the first soft material has a mesh size of around 2 to 4 mm.

18. The sail propulsion element according to claim 15, wherein the second soft material has a mesh size of around 2 to 4 mm.

19. The sail propulsion element according to claim 14, wherein the rib comprises a central band which extends from the leading edge to the trailing edge.

20. The sail propulsion element according to claim 15, wherein the rib comprises a central band which extends from the leading edge to the trailing edge, and
wherein the central band is made from the composite second soft material.

21. The sail propulsion element according to claim 19, wherein the central band has a width ranging from 1 to 10 cm.

22. The sail propulsion element according to claim 14, wherein the plurality of cells are spaced apart by a distance of between 0.8 and 2 m.

23. The sail propulsion element according to claim 14, wherein discrete reinforcers are positioned evenly along the leading edge.

24. The sail propulsion element according to claim 23, further comprising a guide line positioned in the at least one cavity of the inflatable sail, for the maneuvers of hoisting and dropping the inflatable sail, the guide line extending from the leading edge to the trailing edge of the inflatable sail, passing through the headboard and the sail receptacle, the guide line passing through the discrete reinforcers.

25. A vehicle with sail propulsion or hybrid propulsion comprising at least one sail propulsion element according to claim 14, a hull and a mast secured to the hull and retaining a degree of freedom to rotate, wherein most of the mast is positioned inside the at least one cavity of the inflatable sail.

26. The vehicle according to claim 25, wherein the inflatable sail is oriented according to a wind direction and according to a direction of travel of the vehicle either manually or automatically.
